(19) United States
(12) Patent Application Publication
(10) Pub. No.: US 2026/0302989 A1
(43) Pub. Date: Oct. 1, 2026

(54) SLEWING CONTROL SYSTEM, VOLTAGE DEVIATION CONTROL METHOD, CONSTRUCTION MACHINERY INCLUDING THE SYSTEM

(71) Applicant: Caterpillar Inc., Peoria, IL (US)

(72) Inventors: Tao MENG, Wuxi (CN); Lin ZHANG, Wuxi (CN); Xin WU, Wuxi (CN); Erbing SHANG, Wuxi (CN)

(21) Appl. No.: 19/477,193

(22) PCT Filed: Apr. 3, 2024
(86) PCT No.: PCT/US2024/022708

§ 371 Date: Oct. 21, 2025

(30) Foreign Application Priority Data
Apr. 23, 2023 (CN) 202310440250.6

(51) Int. Cl. H02P 23/14; E02F 9/12; H02P 5/00

(52) U.S. Cl. CPC H02P 23/14; E02F 9/123; E02F 9/128; H02P 5/00

(57) ABSTRACT

This disclosure relates to a slewing control system for construction machinery, which comprises a generator and at least one motor connected in series within the circuit loop. The system also comprises a master controller, at least one slave controller, and plurality of feedback units. The master controller is configured to receive an operation command from the user on the slewing handle and provide corresponding excitation current to the generator based on the command. The plurality of feedback units correspond one-to-one with the at least one motor (M1, M2) and the generator (G), and are used to detect the operation parameters of the respective motor or generator and feedback the results to the master controller. The master controller is further configured to adjust the excitation current provided to the generator based on the detection results from the plurality of feedback units. This disclosure also encompasses construction machinery that comprises this slewing control system and a voltage deviation control method for the system.

### TECHNICAL FIELD

The present disclosure relates to the field of construction machinery, more particularly, to a slewing control system for construction machinery, a construction machinery including the slewing control system, as well as a voltage deviation control method for the slewing control system.

### BACKGROUND

During the process of loading, transporting, and unloading materials by construction machinery such as electric shovels, bulldozers, and loaders, a slewing/rotary mechanism is typically required to perform slewing movements.

Taking the 295B electric shovel produced and sold by Caterpillar Inc. as an example, the slewing control system used to drive and control the slewing mechanism mainly consists of a direct current generator and two rotary motors of the same type connected in series in a circuit loop, hence the motor armature current is identical to the generator armature current. The current slewing control system has a simple circuit design and cannot achieve real-time monitoring of the circuit loop and the two rotary motors.

However, due to the influence of operation time and damage to external transmission components, the internal resistance of the two rotary motors may differ, leading to inconsistent voltage results (also referred to herein as “voltage imbalance”) of the two motors. The voltage imbalance of the motors may further cause the two rotation shafts in the slewing mechanism to drag each other due to torque imbalance, which not only accelerates the damage and aging of the motors but also reduces the operation efficiency of the entire slewing mechanism.

In addition, the slewing mechanism needs to be frequently started and stopped during the loading and unloading of the materials. In order to complete the slewing movement quickly, operators usually push the slewing operating handle to the maximum limit position at the beginning of the starting/stopping process, and correspondingly, the excitation current of the generator is rapidly accelerated to the target value. This process causes significant impact and abrasion on the execution devices in the slewing mechanism, severely reducing the service life of the slewing mechanism.

### SUMMARY OF THE INVENTION

To solve the above-mentioned drawbacks of the prior art, the first aspect of the present disclosure provides a slewing/rotary control system for construction machinery, which comprises a generator and at least one motor connected in series in a circuit loop. The generator is configured to generate electrical energy, and the at least one motor is configured to drive the slewing mechanism of the construction machinery to perform a corresponding operation based on the electrical energy provided by the generator. The system also comprises a master controller, at least one slave controller, and a plurality of feedback units.

The master controller is configured to receive an operation command from the user on the slewing handle and provide corresponding excitation current to the generator based on the command. The master controller is also configured to send the operation command to the at least one slave controller.

The at least one slave controller is in one-to-one correspondence with the at least one motor and is configured to adjust the excitation magnetic field of the corresponding motor based on the operation command from the master controller. The at least one motor is configured to drive the slewing mechanism of the construction machinery to perform a corresponding operation under the action of the excitation magnetic field generated by the generator based on the armature current produced by the generator.

The plurality of feedback units are in one-to-one correspondence with the at least one motor and the generator, and are used to detect the operation parameters of the corresponding motor or generator and feedback the detection results to the master controller. The master controller is further configured to adjust the excitation current provided to the generator based on the detection results from the plurality of feedback units.

In an optional embodiment, the plurality of feedback units comprise isolation feedback modules for detecting the armature current on the circuit loop and/or the motor voltage of the at least one motor.

In an optional embodiment, the at least one motor comprises a first motor and a second motor, which are connected to the first rotation shaft and the second rotation shaft of the slewing mechanism of the construction machinery respectively, and are configured to drive the first rotation shaft and the second rotation shaft to perform a corresponding operation based on the electrical energy provided by the generator.

In an optional embodiment, the at least one slave controller comprises a first slave controller and a second slave controller, which are respectively used to control the excitation magnetic field of the first motor and the second motor.

In an optional embodiment, the plurality of feedback units comprise a first isolation feedback module, a second isolation feedback module, and a third isolation feedback module. The first and second isolation feedback modules are respectively used to detect the motor voltage of the first motor and the second motor, and the third isolation feedback module is used to detect the armature current on the circuit loop.

The master controller is further configured to selectively perform a balancing adjustment operation on one of the first motor and the second motor based on the detection results from the first, second, and third isolation feedback modules.

The second aspect of the present disclosure provides construction machinery that comprises the slewing control system as described above.

The third aspect of the present disclosure provides a voltage deviation control method for the slewing control system as described above, where the at least one motor comprises plurality of motors. The method comprises the following steps:
detecting the operation parameters of the plurality of motors and the generator by means of the plurality of feedback units;

determining whether there is a voltage deviation among the plurality of motors based on the detection results from the plurality of feedback units; and
performing a balancing adjustment operation on the corresponding motor in case of a voltage deviation existing among the plurality of motors.

In an optional embodiment, the method further comprises the following steps:
Using the plurality of feedback units to detect the armature current on the circuit loop;
Calculating the output voltage of the generator based on the detected armature current; and
Determining whether the sum of the motor voltages of the plurality of motors is within the predetermined deviation range of the output voltage of the generator.

The judgment step is only performed when the sum of the motor voltages of the plurality of motors is within the predetermined deviation range of the output voltage of the generator; otherwise, if it is determined that the sum of the motor voltages of the plurality of motors is outside the predetermined deviation range of the output voltage of the generator, a maintenance alert is issued.

In an optional embodiment, in case of voltage deviation existing among the plurality of motors, a control command is output to the corresponding slave controller to adjust the excitation magnetic field of the corresponding motor through the slave controller, thereby maintaining output balance among the plurality of motors.

In an optional embodiment, the method further comprises receiving an emergency braking command from user, and when receiving the emergency braking command, applying reverse excitation current to the generator to force the corresponding motor to reverse and slow down.

In an optional embodiment, the method further comprises detecting the current rotation speed of the plurality of motors, and taking the current rotation speed of the corresponding motor into consideration when performing an emergency braking operation on the corresponding motor of the plurality of motors.

In an optional embodiment, when receiving the emergency braking command when the current rotation speed of the corresponding motor among the plurality of motors is higher than the upper limit value, applying a reverse excitation current to the generator for a predetermined duration to force the corresponding motor to reverse and slow down before a braking action is activated.

In an optional embodiment, the method further comprises: based on the operation command from the user on the slewing handle, judging whether it is necessary to change the operation direction of the slewing mechanism, and loading the excitation current of the generator to the target value with variable acceleration when it is determined that it is necessary to change the operation direction of the slewing mechanism.

In an optional embodiment, when it is determined that there is no need to change the operation direction of the slewing mechanism, the excitation current of the generator is loaded to the target value with constant acceleration.

According to the slewing control system for a construction machinery and the voltage deviation control method thereof of the present disclosure, by monitoring the operation conditions of the generator and each motor, it is possible to perform a balancing adjustment operation (for example, by fine-tuning the excitation current) on the corresponding motor timely when a voltage imbalance occurs between the motors, thereby ensuring that the output torque and rotation speed of each motor remain balanced. In addition, real-time monitoring of armature current and motor voltage can be achieved, and safety protection can also be provided, especially for the starting, stopping, and emergency braking of the slewing mechanism, based on the monitoring results.

Therefore, the safety, operability, and service life of the system can be significantly improved.

### BRIEF DESCRIPTION OF THE DRAWINGS

Other features and advantages of the present disclosure will be apparent from, or are set forth in more detail in, the accompanying drawings, which are incorporated herein, and the following detailed description of the embodiments, which together serve to explain certain principles of the present disclosure.

FIG. 1 shows a structural diagram of the slewing control system in prior art.

FIG. 2 shows a schematic diagram of a slewing control system for a construction machinery according to an exemplary embodiment of the present disclosure.

FIG. 3 shows a schematic diagram of the control and feedback relationships between various modules in the slewing control system according to an exemplary embodiment of the present disclosure.

FIG. 4 shows an operation flowchart of the soft starting/braking process of the slewing control system in FIG. 2.

FIG. 5 shows a comparison of the current profile in the slewing control system according to the present disclosure with the current profile in a conventional slewing control system.

FIG. 6 shows a flowchart of the voltage balancing control process performed on the slewing control system in FIG. 2.

FIG. 7 shows an operation flowchart of the emergency braking process of the slewing control system as in FIG. 2.

### DETAILED DESCRIPTION OF THE EMBODIMENTS

A slewing control system for a construction machinery and a voltage deviation control method thereof according to the present disclosure will be described below by way of embodiments with reference to the accompanying drawings. In the following description, numerous specific details are set forth in order to provide a more thorough understanding of the present disclosure to those skilled in the art. It will be apparent, however, to those skilled in the art, that the present disclosure may be practiced without some of these specific details. Rather, any combination of the following features and elements, whether related to different embodiments or not, is contemplated to implement the disclosure. Thus, the following aspects, features, embodiments and advantages are merely illustrative and should not be considered elements or limitations of the claims.

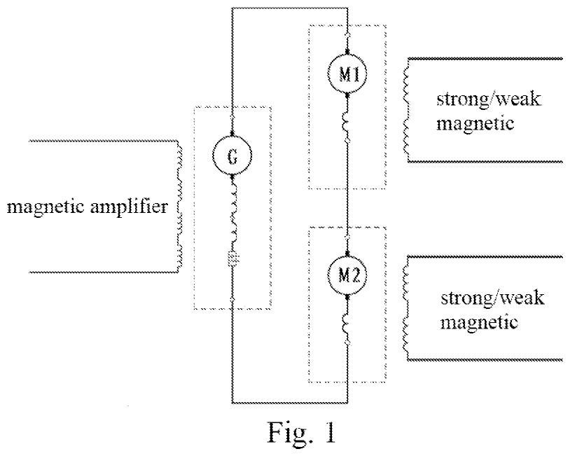

FIG. 1 illustrates a structural diagram of the slewing control system in prior art. As shown in FIG. 1, the system comprises a generator G and two motors M1, M2 connected in series in a circuit loop, where the generator Gis used to generate electrical energy. The two motors may drive the slewing mechanism of the construction machinery to perform a corresponding operation based on the electrical energy provided by the generator.

In the slewing control system, a magnetic amplifier is used to control the generator and the excitation coils of the two motors in the circuit loop, specifically, to change the magnitude and polarity of the excitation current in the excitation coils. The main control occurs in the excitation amplifier of the generator, which is used to change the magnitude and direction of the excitation current of the generator. The motor excitation magnetic field only has two states: i.e. a strong magnetic state during operation and a weak magnetic state during standby.

A negative feedback for cutoff current may be provided in the control loop, i.e. when the loop current (i.e., the armature current of the generator) reaches a threshold value (taking the 295B electric shovel as an example, this threshold value is 670A), the current negative feedback is triggered. At this time, the magnetic amplifier controls the excitation current/field of the generator, thereby reducing the rotation speed of the motor and providing larger torque. At the same time, the armature current is limited not to exceed the maximum value (taking the 295B electric shovel as an example, this maximum value is 700A) to ensure that the motor and control system are not damaged due to excessive current.

However, in the slewing control system, the slewing mechanism is frequently started and stopped during the loading and unloading of materials. When the operator starts the system through the slewing operating handle T, the system provides a small constant current to the excitation coils of the motors to form a weak magnetic field in the motors. When the operator gives a slewing command through the operation of the slewing handle T, the system changes the current in the excitation coils of the motors to a larger value, thus changing the weak magnetic field to a strong magnetic field. At the same time, the magnetic amplifier provides excitation current to the excitation coil of the generator based on the slewing command on the slewing handle, the generator supplies power to the motors, the motor brake is released, and the motor starts to rotate, thereby driving the slewing mechanism to perform the slewing action.

When the operator gives a slewing stopping command by operating the slewing handle, the system changes the current value in the excitation coils of the motors into a smaller value, thus changing the strong magnetic field to a weak magnetic field. Meanwhile, the magnetic amplifier stops providing excitation current to the excitation coil of the generator, and the motor brake operates, thus stopping the slewing action of the slewing mechanism.

In the above process, due to the frequent switching between starting and stopping actions of the slewing mechanism, the slewing mechanism suffers from significant impact and abrasion, which seriously reduces the service life of the slewing mechanism. In addition, the circuit design of the system is relatively simple, and the negative feedback of the excitation current may be triggered only when the armature current reaches a cutoff threshold value. Thus, it can neither realize a whole-process monitoring of the circuit loop nor achieve a definition of the rate of change of the excitation current.

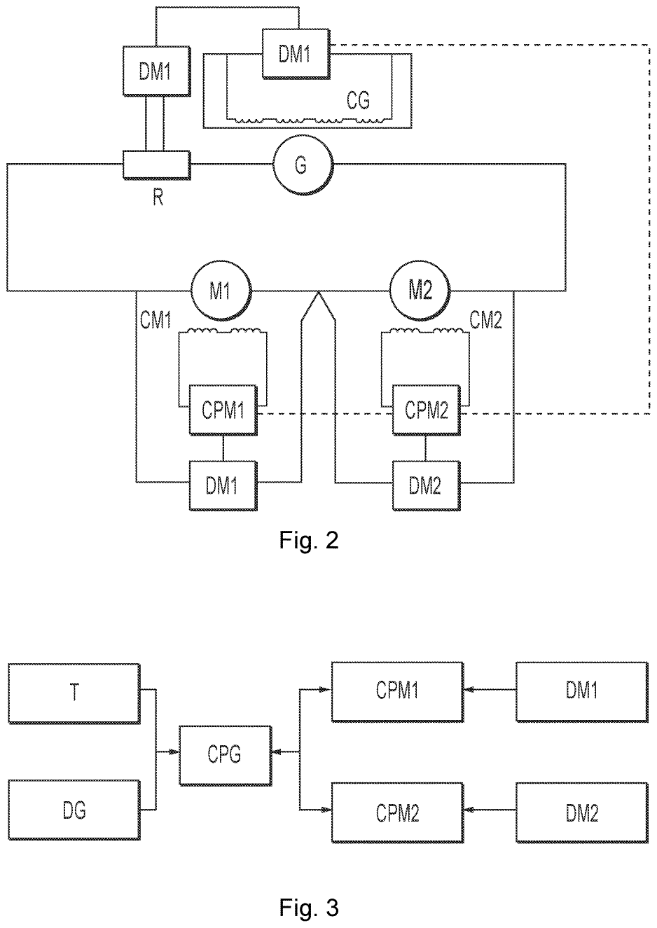

In order to solve the above defects in the existing slewing control system, the present disclosure proposes a new slewing control system. FIG. 2 shows a schematic diagram of a slewing control system for construction machinery according to an exemplary embodiment of the disclosure. The detailed structure of the slewing control system is described in detail below with reference to FIG. 2.

Firstly, the system comprises a generator G and at least one motor M1, M2 connected in series in a circuit loop, wherein the generator G is used to generate electrical energy. For example, the generator may be coupled to the engine of the construction machinery, thereby using the mechanical energy provided by the engine to generate electrical energy. The motor may drive the slewing mechanism of the construction machinery to perform a corresponding operation based on the electrical energy provided by the generator.

It is understandable that the number of rotary motors may be determined according to the structure and design of the slewing mechanism of the construction machinery, for example, it may be one, two, or more. In this context, two motors (i.e., the first motor M1 and the second motor M2) are taken as an example. The first motor M1 and the second motor M2 may be respectively connected to the first rotation shaft and the second rotation shaft of the construction machinery (e.g., an electric shovel), and may respectively drive the first rotation shaft and the second rotation shaft to perform a corresponding operation based on the electrical energy provided by the generator.

Correspondingly, the slewing control system may further comprise a master controller CPG, a first slave controller CPM1, and a second slave controller CPM2, which are used to control the generator G, the first motor M1, and the second motor M2, respectively. The master controller CPG may be configured to receive an operation command from a user on the slewing handle T and provide a predetermined excitation current to the generator G based on the operation command, thereby exciting the generator G to generate a corresponding loop current (i.e., the armature current of the generator) in the circuit loop. It will be appreciated that the number of slave controllers depends on the number of rotary motors in the system.

In addition, the master controller CPG may also transmit the operation command from the user to the first slave controller CPM1 and the second slave controller CPM2, where the first slave controller CPM1 and the second slave controller CPM2 are configured to adjust the excitation magnetic field of the first motor M1 and the second motor M2, respectively, based on the operation command (for example, by adjusting the magnitude of the excitation current in the excitation coil of the corresponding rotary motor), so that the first motor M1 and the second motor M2 may drive the first rotation shaft and second rotation shaft of the slewing mechanism, respectively, to perform a corresponding operation based on the armature current generated by the electric generator under the action of the corresponding excitation magnetic field.

The slewing control system may further comprise plurality of feedback units, which are used to detect the operation parameters of at least one of the first motor M1, the second motor M2, and the generator G, and feedback the detection results to the master controller CPG. The master controller CPG may evaluate the operation status of each unit based on the detection results provided by the plurality of feedback units, and thus adjust the excitation current of at least one of the generator G, the first motor M1, and the second motor M2.

As an optional example shown in FIG. 2, the plurality of feedback units may comprise three isolation feedback modules DM1, DM2, DG, which are used to detect the motor voltage of the first motor M1, the motor voltage of the second motor M2, and the armature current (i.e., the loop current) of the generator G, respectively.

FIG. 3 shows a schematic diagram of the control and feedback relationships between various modules in the slewing control system according to an exemplary embodiment of the disclosure.

When the driver starts the slewing mechanism, the master controller CPG receives the starting command and transmits the starting command to the slave controllers CPM1, CPM2 of the two rotary motors. The slave controllers provide a small current setting value to the corresponding excitation coils CM1, CM2 of the respective rotary motors to maintain the two rotary motors in a low excitation magnetic field.

When the driver operates the slewing handle T, the master controller CPG of the generator receives the slewing starting/stopping command and provides the corresponding initial excitation current and change rate to the excitation coil CG of the generator G, thereby exciting the generator G to generate an armature current that varies synchronously with the initial excitation current in the circuit loop. The generator in turn provides the corresponding armature current and change rate to the rotary motors M1, M2, and at the same time, the master controller CPG of the generator also transmits the starting/stopping command received from the slewing handle to the slave controllers CPM1, CPM2 of the rotary motors, so that the excitation magnetic field of the motors becomes strong magnetic. At this time, the rotary motor brake is released, and when there is armature current flowing in the circuit, the motor rotates to drive the slewing mechanism to complete the corresponding slewing action. When the driver gives a slewing stop command by operating the slewing handle T, the opposite action is performed.

In the above starting/stopping control process, the three isolation feedback modules may respectively transmit the armature current in the circuit and the voltage signals of the two rotary motors to the master controller CPG, where the voltage signals of the two motors may be directly transmitted to the master controller CPG from the isolation feedback modules DM1, DM2, or may be transmitted to the master controller CPG through the slave controllers CPM1, CPM2. Thus, the master controller CPG may then adjust the excitation current of the generator and/or the motor based on this information.

The slewing control system according to the disclosure is characterized in that it has a soft starting/braking function, which may greatly reduce the impact on the slewing mechanism during starting/stopping operations. Specifically, upon receiving the operation starting/stopping command, if the command is confirmed to be valid, the master controller CPG may load the excitation current of the generator G from the current value to the target value at a setting change rate, thereby exciting the generator G to generate an armature current, that changes synchronously with the excitation current, in the circuit loop.

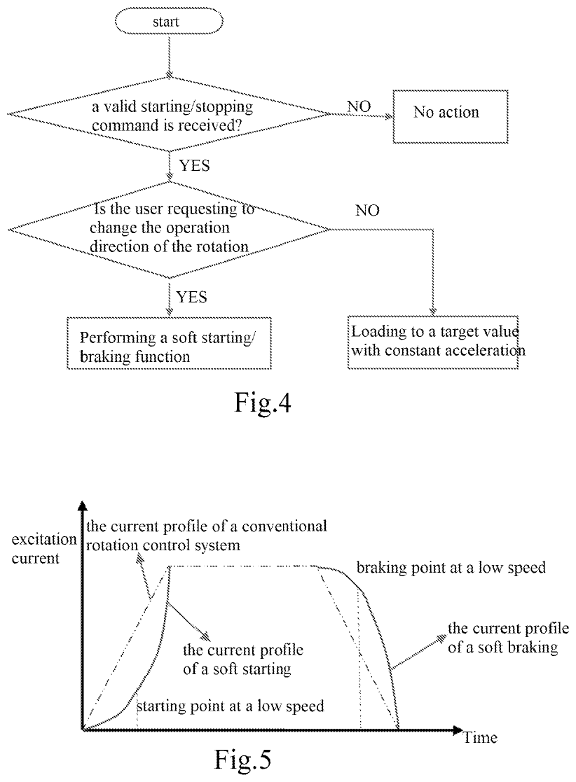

FIG. 4 shows an operation flowchart of the soft starting/braking process of the slewing control system as shown in FIG. 2. The implementation steps of the soft starting/braking process are introduced below with reference to FIG. 4.

Firstly, the master controller CPG receives the operation command from the user on the slewing handle and confirms whether the command is valid. If valid, the master controller CPG further determines whether it is necessary to change the operation direction of the slewing mechanism based on the operation command, and determines the magnitude and change rate of the excitation current applied to the generator G based on this determination result.

FIG. 5 shows a comparison of the current profile in the slewing control system according to the present disclosure with the current profile in a conventional slewing control system.

When it is determined that there is no need to change the operation direction of the slewing mechanism, the master controller CPG may load the excitation current of the generator G from the current value to a target value at a constant acceleration, similar to the conventional current control manner.

When it is determined that a change in the operation direction of the slewing mechanism is required, a soft starting/braking function of the slewing control system may be initiated. Specifically, the master controller CPG may load the excitation current of the generator G from the current value to a target value at a variable acceleration. For example, the excitation current of the generator G is first loaded from the current value to an intermediate value at a lower uniform acceleration, and then from the intermediate value to the target value at a higher uniform acceleration, where the intermediate value is between the current value and the target value of the excitation current, for example, it may be set to one quarter of the target value.

During the process of loading and unloading materials by construction machinery, the slewing mechanism needs to be frequently switched between starting and stopping actions, causing a significant impact on the slewing mechanism. In this process, by combining the soft starting/braking function, the slewing mechanism, especially the electric transmission equipment, may be better protected.

In addition, in the slewing control system, in order to ensure balanced and stable operation of the slewing mechanism, the two motors on the circuit loop are usually of the same type, and it is expected that the torque outputs of the two remain the same. However, due to the influence of operation time and damage to external transmission components, etc., the internal resistance of the two rotary motors may differ, leading to inconsistent voltage results (also referred to as “voltage imbalance” in this text) of the two motors.

In the existing slewing control system, the circuit design is relatively simple and cannot achieve real-time monitoring of the operation conditions of the two rotary motors. Therefore, it is impossible to effectively control the voltage imbalance of the two series-connected motors, which may lead to different rotation speeds and output torques of the two motors (i.e., output imbalance). The torque imbalance cause the two rotation shafts in the slewing mechanism to drag each other, which not only further accelerates the damage and aging of the motors but also reduces the operation efficiency of the entire slewing mechanism.

The above problem is due to that the conventional slewing control system only has strong/weak magnetic setting of the same value for the excitation of the rotary motors connected in series, and it is impossible to fine-tune the strong magnetic field according to the current motor status, so that the torque output and the rotation speed of the motor cannot be synchronized. To address this defect in the conventional slewing control system, the slewing control system according to the disclosure is further characterized in the addition of an independent motor excitation controller to adjust the excitation current of the rotary motors, and the addition of an independent isolation feedback module to read the output voltage of the two rotary motors in real-time and to compare the difference between the two voltages. When the difference is too large and it is necessary to adjust and synchronize the output torque and rotation speed of the two motors, the excitation controller of the respective rotary motor may adjust the output of the respective motor according to the difference, and send out a maintenance prompt if necessary.

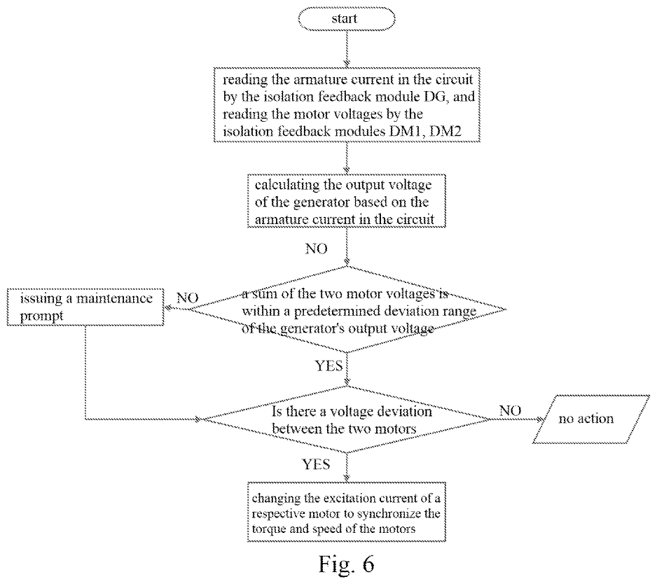

FIG. 6 shows a flowchart of the voltage balancing control process performed on the slewing control system as shown in FIG. 2. The process is described in detail below with reference to FIG. 6.

Firstly, the motor voltages of the two rotary motors are read by the first and second isolation feedback modules DM1, DM2, respectively, and the armature current in the circuit are read by the third isolation feedback module DG. The master controller may further calculate the output voltage of the generator based on the armature current, for example, the output voltage is equal to the product of the armature current and the resistance of the sampling resistor R.

Based on the above detection results provided by the feedback modules, the master controller CPG may determine whether there is a voltage imbalance between the first motor M1 and the second motor M2, and perform balancing adjustment operation on the corresponding motor in case of voltage imbalance. For example, in the case where it is determined that there is a voltage imbalance between the first motor M1 and the second motor M2, a control command is output to the first slave controller CPM1 or the second slave controller CPM2, so as to adjust the excitation magnetic field of the corresponding motor through the first slave controller CPM1 or the second slave controller CPM2, thereby maintaining output balance between the two motors.

Specifically, upon receiving feedback signals from the isolation feedback modules, the master controller CPG may determine whether there is a deviation between the motor voltage of the first motor M1 and the motor voltage of the second motor M2, and perform balancing adjustment operation on the corresponding motor in case of a deviation. Here, “deviation” should be understood as the difference between the two motor voltages exceeding a set threshold.

Optionally, it is possible to exclude un-adjustable deviation situations in advance before the balancing adjustment operation is performed. Specifically, the master controller CPG may first determine whether the sum of the two motor voltages is within the predetermined deviation range of the output voltage of the generator, where the above-described step of “determining whether there is a deviation between the motor voltage of the first motor M1 and the motor voltage of the second motor M2” is performed only in a case where the sum of the two motor voltages is within the predetermined deviation range (e.g., ±15%) of the output voltage. Otherwise, if the deviation is too large to be adjusted, a maintenance alert is sent directly to the user.

Although the balancing adjustment operation is described herein in connection with the slewing control system having two motors as shown in FIG. 2, it is to be understood that the operation principle and method are equally applicable to slewing control system embodiments having more than two motors.

In addition, when an emergency braking situation occurs, for example, an internal monitoring error (such as communication loss) occurs in the excitation controller of the generator, a high-temperature alarm occurs in the motor, etc., or an operator operates the emergency braking switch, an emergency braking strategy may be performed. The conventional emergency braking strategy is to interrupt the supply of all excitation currents and activate a brake holding mechanism to the rotary motors to brake the rotation by means of a braking force.

However, the above emergency braking process has a significant safety hazard, especially when the rotary motor is operated at high speed. If a braking is directly performed without a deceleration operation, it is very likely that the braking force of the brake holding mechanism cannot overcome the inertia, resulting in a “runaway” phenomenon where the brake mechanism fails. If the brake mechanism fails, it naturally cannot stop the rotation of the motor.

Against the above background, the present disclosure proposes a safer emergency braking strategy, which is capable of providing a reverse rotation current to the motor to facilitate the stop or deceleration of the slewing mechanism, thereby ensuring that the subsequent braking action is sufficient to brake the slewing mechanism successfully.

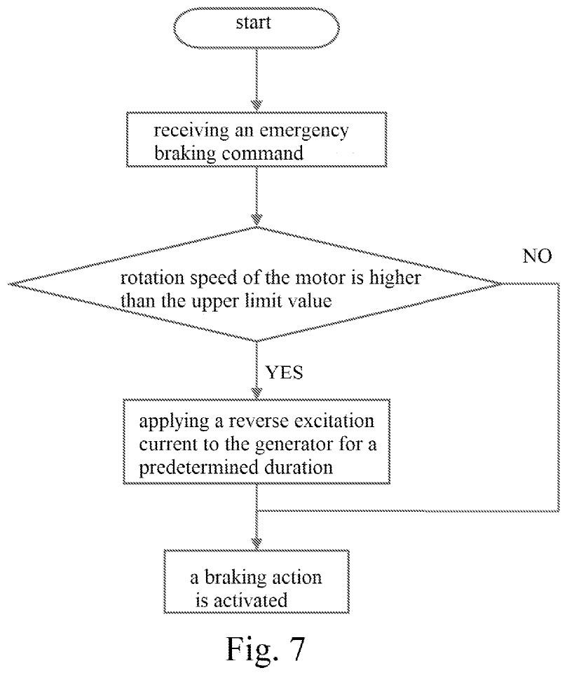

FIG. 7 shows an operation flowchart of the emergency braking process of the slewing control system as shown in FIG. 2. The implementation steps of the emergency braking process are introduced below with reference to FIG. 7.

Firstly, the master controller CPG may receive an emergency braking command from a user (input through the emergency braking switch on the construction machinery), and apply reverse excitation current to the generator G, upon receiving the emergency braking command, to force the respective motor to reverse and slow down. Specifically, by changing the direction of the generator excitation current, the armature current is reversed, and the motor slows down to prepare for the reverse rotation.

Optionally, a plurality of feedback units (e.g., any one of the isolation feedback modules DM1 and DM2) may be further configured to detect the current rotation speed of the motor M1 or M2, and the master controller CPG may take the current rotation speed of the motor M1 or M2 into consideration when performing the emergency braking operation on the slewing mechanism.

Specifically, when the master controller CPG receives an emergency braking command in a case where the current rotation speed of the first motor M1 (or the second motor M2) is higher than the upper limit value, a reverse excitation current is applied to the generator G for a predetermined period of time (for example, 0.5 seconds), so as to force the respective motor to reverse and slow down before a brake mechanism is activated.

According to the slewing control system for a construction machinery and the voltage deviation control method thereof of the present disclosure, by monitoring the operation conditions of the generator and each motor, it is possible to perform a balancing adjustment operation (for example, by fine-tuning the excitation current) on the corresponding motor timely when a voltage imbalance occurs between the motors, thereby ensuring that the output torque and rotation speed of each motor remain balanced. In addition, real-time monitoring of armature current and motor voltage can be achieved, and safety protection can also be provided, especially for the starting, stopping, and emergency braking of the slewing mechanism, based on the monitoring results.

Therefore, the safety, operability, and service life of the system can be significantly improved.

It will be appreciated by those skilled in the art that the steps of the method according to the present disclosure are not limited to the order listed above. In addition, in the present disclosure, the terms “comprising” and “including” indicate that, in addition to the steps directly and explicitly stated in the Description and Claims, the technical solution of the present disclosure does not exclude the case of having other steps which are not directly or explicitly stated herein.

Although the present disclosure has been disclosed with the best embodiment as above, the disclosure is not limited to this. Any modifications and changes made by those skilled in the art without departing from the spirit and scope of the disclosure should be included within the protection scope of the disclosure, and therefore the protection scope of the disclosure should be determined by the scope defined in the Claims.

1. A slewing control system for a construction machinery, comprising a generator (G) and at least one motor (M1, M2) connected in series within a circuit loop, wherein the at least one motor (M1, M2) is configured to drive the slewing mechanism of the construction machinery to perform a respective operation based on the electrical energy provided by the generator (G), characterized in that the system further comprises a master controller (CPG), at least one slave controller (CPM1, CPM2), and a plurality of feedback units (DM1, DM2, DG), wherein:
the master controller (CPG) is configured to receive an operation command from a user on the slewing handle and provide corresponding excitation current to the generator (G) based on the operation command, the master controller (CPG) is further configured to send the operation command to the at least one slave controller (CPM1, CPM2),
the at least one slave controller (CPM1, CPM2) corresponds one-to-one with the at least one motor (M1, M2) and is configured to adjust the excitation magnetic field of the respective motor (M1, M2) based on the operation command from the master controller (CPG), the at least one motor (M1, M2) is configured to drive the slewing mechanism of the construction machinery to perform a corresponding operation based on the armature current generated by the generator under the influence of the excitation magnetic field,
the plurality of feedback units (DM1, DM2, DG) correspond one-to-one with the at least one motor (M1, M2) and the generator (G), and are used to detect the operation parameters of the respective motor (M1, M2) or generator (G) and feedback the detection results to the master controller (CPG), the master controller (CPG) is further configured to adjust the excitation current provided to the generator (G) based on the detection results from the plurality of feedback units.

2. The slewing control system according to claim 1, wherein the plurality of feedback units (DM1, DM2, DG) comprise isolation feedback modules for detecting the armature current on the circuit loop and/or the motor voltage of the at least one motor (M1, M2).

3. The slewing control system according to claim 1, wherein the at least one motor (M1, M2) comprises a first motor (M1) and a second motor (M2), which are respectively connected to the first rotation shaft and the second rotation shaft of the slewing mechanism of the construction machinery, and are configured to drive the first rotation shaft and the second rotation shaft to perform a corresponding operation based on the electrical energy provided by the generator.

4. The slewing control system according to claim 3, wherein the at least one slave controller (CPM1, CPM2) comprises a first slave controller (CPM1) and a second slave controller (CPM2) for controlling the excitation magnetic field of the first motor (M1) and the second motor (M2), respectively.

5. The slewing control system according to claim 3, wherein the plurality of feedback units (DM1, DM2, DG) comprise a first isolation feedback module (DM1), a second isolation feedback module (DM2), and a third isolation feedback module (DG), the first and second isolation feedback modules (DM1, DM2) are used to detect the motor voltages of the first motor (M1) and the second motor (M2) respectively, and the third isolation feedback module (DG) is used to detect the armature current on the circuit loop,
wherein, the master controller (CPG) is further configured to selectively perform a balancing adjustment operation on a respective one of the first motor (M1) and the second motor (M2) based on the detection results of the first, second, and third isolation feedback modules (DM1, DM2, DG).

6. A construction machinery, characterized in that it comprises the slewing control system according to claim 1.

7. A voltage deviation control method for the slewing control system according to claim 1, wherein the at least one motor (M1, M2) comprises a plurality of motors, the method comprises the steps o:
detecting the operation parameters of the plurality of motors and the generator (G) by means of the plurality of feedback units (DM1, DM2, DG);
determining whether there is a voltage deviation among the plurality of motors based on the detection results from the plurality of feedback units; and
performing a balancing adjustment operation on the corresponding motor when there is a voltage deviation among the plurality of motors.

8. The voltage deviation control method according to claim 7, wherein it further comprising the steps of:
detecting the armature current on the circuit loop by means of the plurality of feedback units (DM1, DM2, DG);
calculating an output voltage of the generator (G) based on the detected armature current; and
determining whether a sum of the motor voltages of the plurality of motors is within a predetermined deviation range of the output voltage,
wherein, the determining step is performed only when the sum of the motor voltages of the plurality of motors is within the predetermined deviation range of the output voltage; otherwise, if the sum of the motor voltages of the plurality of motors is determined to be out of the predetermined deviation range of the output voltage, a maintenance alert is issued.

9. The voltage deviation control method according to claim 7, wherein it further comprising the steps of:
outputting a control command to the corresponding slave controller in case of a voltage deviation existing among the plurality of motors, to adjust the excitation magnetic field of the corresponding motor via the slave controller, thereby maintaining output balance among the plurality of motors.

10. The voltage deviation control method according to claim 7, wherein it further comprising the step of:
receiving an emergency braking command from the user, and applying a reverse excitation current to the generator, upon receiving the emergency braking command, to force the corresponding motor to reverse and slow down.

11. The voltage deviation control method according to claim 10, wherein it further comprising the step of:
detecting a current rotation speed of the plurality of motors, and taking the current rotation speed of a respective motor among the plurality of motors into consideration when performing the emergency braking operation on the respective motor.

12. The voltage deviation control method according to claim 10, wherein it further comprising the step of:
when the emergency braking command is received in a case where the current rotation speed of the respective motor among the plurality of motors is higher than the upper limit value, applying reverse excitation current to the generator for a predetermined period of time to force the respective motor to reverse and slow down before a brake mechanism operates.

13. The voltage deviation control method according to claim 7, wherein it further comprising the step of:
determining whether it is necessary to change the operation direction of the slewing mechanism based on the operation command of the user on the slewing handle, and loading the excitation current of the generator (G) to a target value with a variable acceleration when it is determined that it is necessary to change the operation direction of the slewing mechanism.

14. The voltage deviation control method according to claim 13, wherein it further comprising the step of:
loading the excitation current of the generator (G) to the target value with constant acceleration in the case where it is determined that there is no need to change the operation direction of the slewing mechanism.
